(19) United States
(12) Patent Application Publication
(10) Pub. No.: US 2020/0083528 A1
(43) Pub. Date: Mar. 12, 2020

(54) LINEAR HIERARCHICAL STRUCTURE LITHIUM TITANATE MATERIAL, PREPARATION AND APPLICATION THEREOF

(71) Applicant: PETROCHINA COMPANY LIMITED, Beijing (CN)

(72) Inventors: Jianming LI, Beijing (CN); Xu JIN, Beijing (CN); Xiaoqi WANG, Beijing (CN); Liang SUN, Beijing (CN); Ling SU, Beijing (CN); Xiaodan LIU, Beijing (CN)

(73) Assignee: PETROCHINA COMPANY LIMITED, Beijing (CN)

(21) Appl. No.: 16/562,418

(22) Filed: Sep. 5, 2019

(30) Foreign Application Priority Data
Sep. 6, 2018 (CN) 201811038606.9

(51) Int. Cl. H01M 4/485; H01M 10/0525; H01M 10/054; C01G 23/00

(52) U.S. Cl. CPC H01M 4/485; H01M 10/0525; H01M 2004/021; C01G 23/005; H01M 10/054

(57) ABSTRACT

A linear hierarchical structure lithium titanate material, preparation and application thereof. The crystal phase of the lithium titanate material is a spinel-type crystal phase or a monoclinic crystal phase or a composite crystal phase thereof; the lithium titanate material is mainly composed of a linear hierarchical structure; the linear hierarchical structure has an aspect ratio larger than 10; and the surface components of the linear hierarchical structure are nanosheets. The long-axis of the linear structure facilitates the effective migration of electrons, and the sheet-like hierarchical structure facilitates the rapid intercalation and deintercalation process of lithium ions, sodium ions or potassium ions, and a large specific surface area facilitates the contact area between the electrolyte solution and the electrodes and reduces the current density, thus is excellent in a rapid charge-discharge performance of the battery.

### CROSS-REFERENCE TO RELATED APPLICATIONS

This application claims the benefit of and priority to Chinese Patent Application No. 201811038606.9, filed Sep. 6, 2018, which is incorporated herein by reference in its entirety.

### TECHNICAL FIELD

The invention relates to the field of energy, and in particular, to a linear hierarchical structure lithium titanate material, preparation and application thereof.

### BACKGROUND

As an ideal and promising negative electrode material for lithium-ion battery, lithium titanate may have a charge-discharge cycle number up to thousands, and thus become a hot spot in the field of electrode material research.

The use of lithium titanate in lithium-ion battery may be influenced largely by its size and morphology. For example, a hierarchical structure material can well preserve the microstructural function of the material while sufficiently making use of the nanostructure properties of the material. The components of the hierarchical structure material are generally small nanoparticles, which can increase the specific surface area of the material and improve the nanoscale performances of the material; the hierarchical structure material is in micron scale as a whole, which is beneficial to the accumulation between whole particles, and can greatly improve the rapid charge and discharge performance of the battery. In addition, as compared with the particles, the linear structure lithium titanate material can reduce the grain boundary between the particles and facilitate the transport of carriers in the long-axis direction. In the field of electrode materials for battery, the long axis may facilitate the effective migration of electrons and the short axis may facilitate the rapid intercalation and deintercalation of lithium, sodium or potassium ions. The linear structure has better charge-discharge performance and the like than the particulates. Therefore, the linear hierarchical structure lithium titanate material can greatly improve the specific surface area of the material, enhance the surface activity of the material, reduce grain boundaries between the particles and improve the effective transport of carriers in the long-axis direction, which can greatly improve the application performance of the material in a battery electrode in terms of capacity and rapid charge-discharge.

The existing methods for producing lithium titanate mainly include solid state synthesis and hydrothermal reaction preparation. Among them, the solid state synthesis method generally includes, firstly mixing well raw materials such as lithium hydroxide or lithium carbonate and titanium oxide by means of ball milling or in an organic solvent, and then sintering the resultant at a high temperature of more than 800° C. to obtain lithium titanate. The preparation method requires an excess of lithium hydroxide or lithium carbonate, and the obtained lithium titanate generally has a low purity, a size of micron scale, and poor morphology and uniformity. The hydrothermal preparation method for lithium titanate usually involves: producing sodium titanate by a hydrothermal process using commercial titanium oxide and sodium hydroxide as starting materials, and immersing sodium titanate into an acid solution to obtain titanic acid by ion exchange; and then mixing the titanic acid with a lithium hydroxide solution or a lithium titanate precursor followed by annealing the product at different temperatures to obtain the lithium titanate product. The hydrothermal process in the preparation method involves a high temperature and a high pressure, which is dangerous to some extent. Meanwhile, the reaction system is a strong alkali of 10 mol/L, which is highly corrosive at high temperatures. Thus, it has a harsh requirement for hydrothermal reaction apparatus, and it may be difficult to find a suitable reaction apparatus. In addition, the preparation method uses an alkali at a high concentration, which makes the subsequent product separation and purification difficult, and also brings pollution to the environment. Therefore, the hydrothermal preparation method for lithium titanate still faces many difficulties in the synthesis apparatus and subsequent processing, and the mass production cannot be realized.

To sum up, in order to further improve the application performance of lithium titanate materials in the field of lithium-ion battery, it is urgent to develop a lithium titanate electrode material having a linear hierarchical structure. In addition, the development of a method for producing lithium titanate having a simple technological process and easy for large-scale production, especially a method for producing a lithium titanate material having a linear hierarchical structure, still faces great technical challenges.

### SUMMARY

It is an object of the disclosure to provide a linear hierarchical structure lithium titanate material.

It is another object of the disclosure to provide a method for preparing the linear hierarchical structure lithium titanate material.

It is still another object of the disclosure to provide an electrode material for an ion battery.

In order to achieve the above objects, in one aspect, the disclosure provides a linear hierarchical structure lithium titanate material, wherein the crystal phase of the lithium titanate material is a spinel-type crystal phase or a monoclinic crystal phase or a composite crystal phase thereof; the lithium titanate material is mainly composed of a linear hierarchical structure; and the surface components of the linear hierarchical structure lithium titanate material are nanosheets.

According to some specific embodiments, the surface of the linear hierarchical structure lithium titanate material is further loaded with one or more selected from the group consisting of carbon, carbon nanotubes, graphene, black phosphorus, metals, and semiconductors.

According to some specific embodiments, the linear hierarchical structure has an aspect ratio greater than 10.

According to some specific embodiments, the linear hierarchical structure has an aspect ratio of 10 to 100.

According to some specific embodiments, the linear hierarchical structure is a solid linear structure or a hollow linear structure.

According to some specific embodiments, the linear hierarchical structure has a diameter of 20 nm to 1 μm and a length of 1 μm to 50 μm.

According to some specific embodiments, the linear hierarchical structure has a diameter of 50 nm to 500 nm and a length of 5 μm to 20 μm.

According to some specific embodiments, the nanosheets have a size of 5 nm to 300 nm.

According to some specific embodiments, the nanosheets have a size of 10 nm to 100 nm.

According to some specific embodiments, the nanosheets have a thickness of 1 nm to 20 nm.

According to some specific embodiments, the nanosheets have a thickness of 1 nm to 10 nm.

According to some specific embodiments, the method for preparing the linear hierarchical structure lithium titanate material comprises the following steps:

(1) preparing a linear structure lithium peroxotitanate;

(2) subjecting the linear structure lithium peroxotitanate obtained in the step (1) to a hydrothermal reaction or a solvothermal reaction to obtain a linear hierarchical structure lithium titanate precursor;

(3) subjecting the linear hierarchical structure lithium titanate precursor obtained in the step (2) to an annealing treatment to obtain the linear hierarchical structure lithium titanate material.

According to some specific embodiments, the method further comprises preparing a linear structure lithium peroxotitanate, comprising the followings steps:

(a1) preparing a dispersion containing titanium peroxo-complex;

(b1) adding a lithium compound into the dispersion containing titanium peroxo-complex obtained in the step (a1) to form a solution;

(c1) subjecting the solution obtained in the step (b1) to a reaction under heating to obtain the linear structure lithium peroxotitanate;

or, comprising the followings steps:

(a2) subjecting a titanium source to a hydrolysis reaction to form a hydrated titanic acid precipitate;

(b2) dispersing the hydrated titanic acid precipitate obtained in the step (a2) in an aqueous hydrogen peroxide solution containing lithium hydroxide, and stirring to form a solution;

(c2) subjecting the solution obtained in the step (b2) to a reaction under heating to obtain the linear structure lithium peroxotitanate.

According to some specific embodiments, the method further comprises subjecting the linear structure lithium peroxotitanate obtained in the step (c1) and the step (c2) to a low-temperature treatment for decomposition and removal of peroxy on the surface of the linear structure lithium peroxotitanate, to obtain a linear structure lithium peroxotitanate having peroxy removed on the surface thereof.

According to some specific embodiments, the low-temperature treatment is carried out at a temperature of 120° C. to 200° C. for 1 h to 12 h.

According to some specific embodiments, the system of the hydrothermal reaction is selected from a pure water system, an acidic water system or an alkaline water system; and the hydrothermal reaction is carried out at a temperature of 100° C. to 150° C. for 1 h to 24 h.

It is understood that the pure water system refers to a neutral water system, that is, water having a neutral pH, such as deionized water, domestic water, industrial water, etc.

According to some specific embodiments, the system of the solvothermal reaction is selected from an aqueous alcohol solution system or an alcohol solution system; and the solvothermal reaction is carried out at a temperature of 80° C. to 150° C. for 1 h to 24 h.

According to some specific embodiments, the annealing treatment is carried out at a temperature of 300° C. to 700° C. for 1 h to 24 h.

According to some specific embodiments, the titanium peroxo-complex in the dispersion containing titanium peroxo-complex has a concentration of 0.01 mol/L to 1 mol/L.

According to some specific embodiments, the titanium peroxo-complex in the dispersion containing titanium peroxo-complex has a concentration of 0.05 mol/L to 0.5 mol/L.

According to some specific embodiments, the method further comprises the preparation process of a dispersion containing titanium peroxo-complex, comprising the step of: dispersing a titanium compound into an aqueous peroxide solution to form a dispersion, to obtain the dispersion containing titanium peroxo-complex.

According to some specific embodiments, the titanium compound is selected from one or more of metallic titanium, titanium ethoxide, titanium isopropoxide, tetrabutyl titanate, titanium glycolate, titanium glyceroxide, titanium sulfate, titanium oxysulfate, titanium tetrachloride, titanium tetrafluoride, ammonium fluorotitanate, titanium nitride, titanium oxide, and titanic acid.

According to some specific embodiments, the peroxide is selected from one or more of hydrogen peroxide, urea peroxide and peracetic acid.

According to some specific embodiments, the method further comprises, after dispersing a titanium compound into a peroxide aqueous solution to form a dispersion, adding a polymer into the dispersion to obtain the dispersion containing titanium peroxo-complex.

According to some specific embodiments, the polymer is selected from one or more of chitosan, guar, methyl cellulose, ethyl cellulose, hydroxyethyl cellulose, hydroxypropyl cellulose, hydroxypropyl methyl cellulose, polyvinyl alcohol, polyacrylamide, polyethylene oxide, polyethylene glycol, and polyvinylpyrrolidone.

According to some specific embodiments, the polymer is added in an amount such that the content of the polymer in the obtained dispersion containing titanium peroxo-complex is 0.01% to 10% by mass.

According to some specific embodiments, the polymer is added in an amount such that the content of the polymer in the obtained dispersion containing titanium peroxo-complex is 0.1% to 10% by mass.

According to some specific embodiments, the lithium compound is selected from one or more of lithium hydroxide, lithium oxide, lithium peroxide, and lithium superoxide.

According to some specific embodiments, the lithium compound is used in an amount such that the concentration of lithium ions in the solution formed by adding the lithium compound is 0.4 mol/L to 2.0 mol/L.

According to some specific embodiments, in the step (c1) and the step (c2), the reaction under heating is independently carried out at a temperature of 60° C. to 100° C. for 0.5 h to 24 h.

According to some specific embodiments, the titanium source is selected from one or more of titanium ethoxide, titanium isopropoxide, tetrabutyl titanate, titanium glycolate, titanium glyceroxide, titanium sulfate, titanium oxysulfate, titanium tetrachloride, titanium tetrafluoride, ammonium fluorotitanate, titanium nitride, titanic acid, and industrial titanium-containing compounds.

According to some specific embodiments, in the step (a2), the hydrolysis reaction comprises dispersing the titanium source in water for hydrolysis to produce a hydrated titanic acid precipitate, or, the hydrolysis reaction comprises dispersing the titanium source in an aqueous solution containing an alkaline substance for hydrolysis to produce a hydrated titanic acid precipitate.

According to some specific embodiments, the alkaline substance is selected from one or more of aqueous ammonia, sodium hydroxide, potassium hydroxide, tetramethylammonium hydroxide, tetraethylammonium hydroxide, tetrapropylammonium hydroxide, tetrabutylammonium hydroxide, ethylenediamine, diethylamine, triethylamine, ethylamine, ethanolamine, and diethanolamine.

According to some specific embodiments, the hydrolysis reaction is carried out at normal temperature under normal pressure.

According to some specific embodiments, the step (a2) further comprises a step of purifying the obtained hydrated titanic acid precipitate crude product after hydrolysis and using the purified hydrated titanic acid precipitate in the step (b2); wherein the purification is selected from one or more of water washing—separation by centrifugation, water washing—membrane separation, water washing—filtration and dialysis.

According to some specific embodiments, the purified hydrated titanic acid has a purity of 97% or more.

According to some specific embodiments, in the step (b2), the concentration of lithium hydroxide in the aqueous hydrogen hydroxide solution containing lithium hydroxide is 0.4 mol/L to 2.0 mol/L.

According to some specific embodiments, in the step (b2), the concentration of lithium hydroxide in the aqueous hydrogen hydroxide solution containing lithium hydroxide is 1.0 mol/L to 1.5 mol/L.

According to some specific embodiments, the volume fraction of hydrogen peroxide in the aqueous hydrogen hydroxide solution containing lithium hydroxide is 0.5% to 10%.

According to some specific embodiments, the volume fraction of hydrogen peroxide in the aqueous hydrogen hydroxide solution containing lithium hydroxide is 1% to 3%.

According to some specific embodiments, the method further comprises a step of loading the surface of the obtained linear hierarchical structure lithium titanate material with one or more of carbon, carbon nanotubes, graphene, black phosphorus, metals and semiconductors, when the linear hierarchical structure lithium titanate material is obtained after the annealing treatment in the step (3).

In another aspect, the disclosure further provides a method for preparing the linear hierarchical structure lithium titanate material, wherein the method comprises the steps of:

(1) preparing a linear structure lithium peroxotitanate;

(2) subjecting the linear structure lithium peroxotitanate obtained in the step (1) to a hydrothermal reaction or a solvothermal reaction to obtain a linear hierarchical structure lithium titanate precursor;

(3) subjecting the linear hierarchical structure lithium titanate precursor obtained in the step (2) to an annealing treatment to obtain the linear hierarchical structure lithium titanate material.

In yet another aspect, the disclosure further provides an electrode material for ion battery, wherein the electrode material is mainly composed of any of the linear hierarchical structure lithium titanate material according to the disclosure.

According to some specific embodiments, the ion battery is selected from lithium ion battery, sodium ion battery, potassium ion battery, or magnesium ion battery.

It should be emphasized that the term “comprise/comprising” when used herein, refers to the presence of features, integers, steps or components, but does not preclude the presence or addition of one or more of other features, integers, steps or components.

Features described and/or illustrated with respect to one embodiment may be used in one or more of other embodiments in the same or similar manner, in combination with, or in place of, the features in other embodiments.

Any numerical value recited herein includes all values of the lower and upper values in increments of one unit from the lower limit to the upper limit, provided that there is an interval of at least two units between any lower value and any higher value. For example, if the value of the number of components or a process variable (e.g., temperature, pressure, time, etc.) is stated to be from 1 to 90, preferably from 20 to 80, more preferably from 30 to 70, it is intended that the values such as 15 to 85, 22 to 68, 43 to 51, and 30 to 32 are also explicitly listed in the specification. For a value less than 1, it is appropriately considered that one unit is 0.0001, 0.001, 0.01, or 0.1. These are merely examples that are intended to be expressly stated, and all possible combinations of numerical values recited between the minimum and maximum values are considered to be explicitly described in this specification in a similar manner.

In summary, the disclosure provides a linear hierarchical structure lithium titanate material, and preparation and application thereof. The lithium titanate material has the following advantages:

(1) For the first time, the disclosure provides a linear hierarchical structure lithium titanate material, in which the surface components are nanosheets.

(2) The long axis of the linear structure facilitates the effective migration of electrons, the sheet-like hierarchical structure facilitates the rapid intercalation and deintercalation process of lithium ions, sodium ions or potassium ions, and a large specific surface area facilitates the contact area between the electrolyte solution and the electrodes and reduces the current density, thus is excellent in a rapid charge-discharge performance of the battery.

(3) The preparation technique for the linear hierarchical structure lithium titanate material provided by the method cannot be achieved by other methods.

(4) The hierarchical structure provided by the method can increase the specific surface area of the lithium titanate, increase the contact area with the electrolyte solution when the lithium titanate is used as the electrode material, decrease the current density, and improve the battery performance.

(5) The linear hierarchical structure provided by the method can reduce the grain boundary between the particles, facilitate the transport of carriers in the long-axis direction, and enhance the application effect of the electrode material.

(6) The method has a simple preparation process, is easy to control the process parameters, uses widely available raw materials, has a low production cost, and is easy to apply to a large-scale industrial production.

### BRIEF DESCRIPTION OF THE DRAWINGS

FIG. 1 is an XRD pattern of the lithium titanate material (a spinel-type lithium titanate crystal phase) of Example 1;

FIG. 2 is an SEM image of the lithium titanate material (a linear structure) of Example 1;

FIG. 3 is an SEM image of the linear lithium titanate material (a hierarchical structure) of Example 1;

FIG. 4 is an SEM image of the surface components (nanosheets) of the linear hierarchical structure lithium titanate material of Example 1;

FIG. 5 is a discharge capacity diagram of a lithium ion battery in which the linear hierarchical structure lithium titanate material of Example 1 is used as an electrode material at various charge and discharge rates;

FIG. 6 is an SEM image of the hollow linear structure lithium titanate material of Example 2;

FIG. 7 is a discharge capacity diagram of a lithium ion battery in which the hollow linear structure lithium titanate material of Example 2 is used as an electrode material at various charge and discharge rates;

FIG. 8 is an XRD pattern of the linear hierarchical structure lithium titanate material (a composite crystal phase of spinel-type lithium titanate and monoclinic lithium titanate) of Example 3;

FIG. 9 is an SEM image of the linear hierarchical structure lithium titanate material of Example 3;

FIG. 10 is an XRD pattern of the linear hierarchical structure lithium titanate material (a monoclinic lithium titanate crystal phase) of Example 4; and

FIG. 11 is a SEM image of the linear hierarchical structure lithium titanate material of Example 4.

### DETAILED DESCRIPTION

Hereinafter, the implementation of the disclosure and the beneficial effects thereof are described in detail by way of specific examples, which are intended to provide a better understanding of the essence and characteristics of the disclosure, but do not limit the implementable scope of the disclosure.

### Example 1

Firstly, 2 g of titanium isopropoxide was dispersed in 100 ml of water, and then 5 ml of 30% hydrogen peroxide was added thereto under stirring to form a suspension containing titanium peroxo-complex. Next, 3.5 g of lithium hydroxide was added to the above peroxo-complex suspension under stirring to form a pale-yellow transparent solution. Subsequently, the pale-yellow transparent solution was heated to 80° C. and stirred at a constant temperature for 6 hours to obtain a linear structure lithium peroxotitanate as a white product. The reaction was stopped, and separation and drying were carried out to obtain the white solid. Subsequently, the above white solid was dispersed in 100 ml of water and subjected to a hydrothermal reaction at 120° C. for 6 hours to obtain a linear hierarchical structure lithium titanate precursor. Finally, the linear hierarchical structure lithium titanate precursor obtained above was heated at 450° C. for 4 hours, to obtain a linear hierarchical structure lithium titanate material.

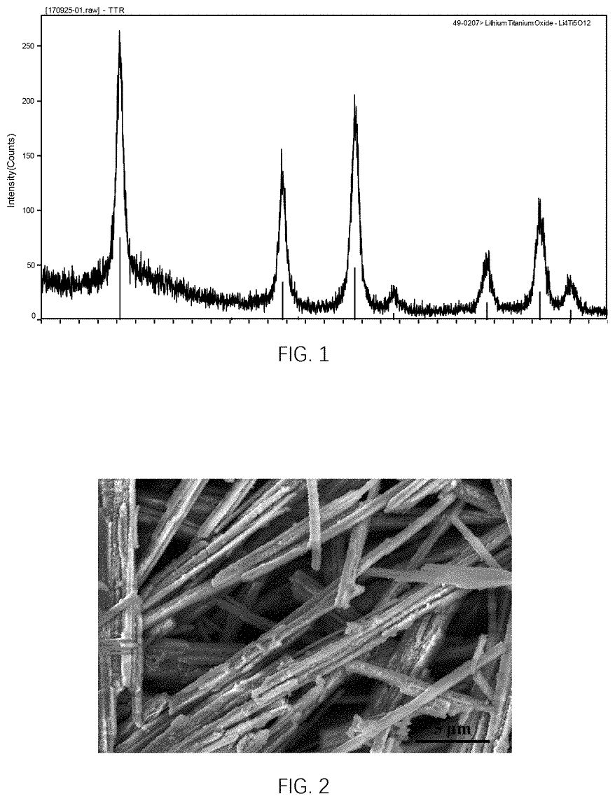

The XRD crystal phase pattern of the linear hierarchical structure lithium titanate material obtained in this example is shown in FIG. 1, which completely coincides with the standard spinel-type lithium titanate (PDF card No.: 49-0207) in its standard peaks. Thus, it is confirmed to be a spinel-type lithium titanate.

The low resolution SEM image of the linear hierarchical structure lithium titanate material obtained in this example is shown in FIG. 2. It can be seen that the linear structure is a solid linear structure and has an aspect ratio of greater than 10, wherein the linear structure having an aspect ratio of 10 to 100 accounts for up to 90% or more. It can also be seen from the Figure that the linear hierarchical structure lithium titanate material has a diameter of 20 nm to 1 μm and a length of 1 μm to 50 μm, wherein the linear structure with a diameter of 50 nm to 500 nm and a length of 5 μm to 20 μm accounts for up to 60%.

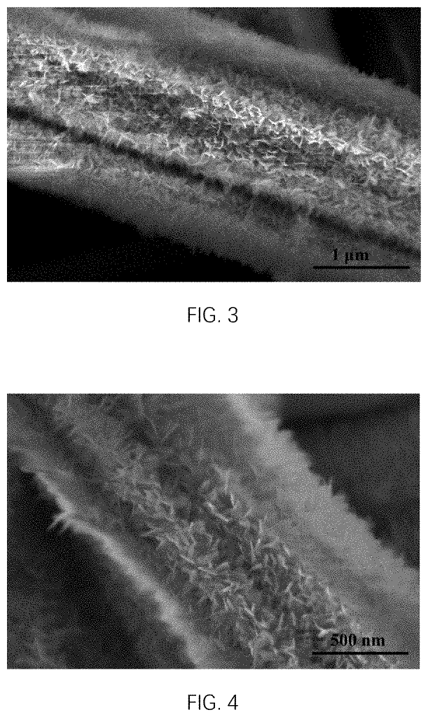

The high resolution SEM image of the linear hierarchical structure lithium titanate material obtained in this example is shown in FIG. 3. It can be seen that the linear structure is a linear hierarchical structure whose surface is composed of nanosheet particles. Nanosheets have a size of 5 nm to 300 nm, wherein the nanosheets having a size of 10 nm to 100 nm account for up to 80%.

The SEM image of the surface nanosheet components of the linear hierarchical structure lithium titanate material obtained in this example is shown in FIG. 4. It can be seen that the nanosheets have a thickness of 1 nm to 20 nm, wherein the nanosheets having a thickness of 1 nm to 10 nm account for up to 80%.

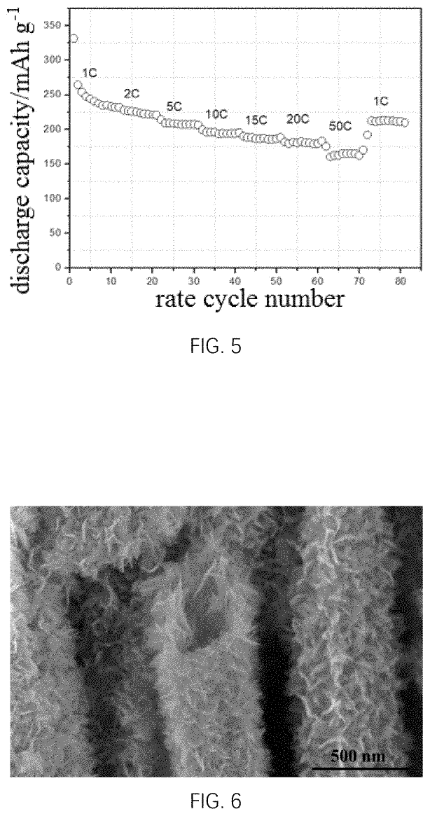

The results of a discharge capacity test of a lithium ion battery having the linear hierarchical structure lithium titanate material obtained in this example as an electrode material at different charge and discharge rates are shown in FIG. 5. The lithium ion battery electrode was prepared using knife coating process. Firstly, a slurry was prepared in a mass ratio of lithium titanate product:Super P:polyvinylidene fluoride (PVDF)=7:2:1 with N-methylpyrrolidone (NMP) as solvent. Subsequently the slurry was uniformly applied on a copper foil using a knife coater, and then a model CR2032 button cell was assembled in a glove box with metallic lithium as a counter electrode, 1 mol/L LiPF₆/EC-DMC-EMC (1:1:1) as the electrolyte solution, and Glass Fiber as a separator and it was electrochemically tested. As can be seen from FIG. 5, the structure of the material has the following characteristics: (1) the linear structure has a large aspect ratio which is mainly 10 to 100, and can greatly reduce the grain boundary between the particles compared with the nanoparticles, facilitate the effective migration of electrons in the long-axis direction, and improve the overall conductivity of the electrode material; (2) the nanosheets of the sheet-like hierarchical structure mainly have a thickness of 1 to 10 nm, which gives a very short lithium ion migration path, and thus can quickly improve the intercalation and deintercalation process of lithium ions and enhance the rate charge and discharge performance; (3) the hierarchical structure has a large specific surface area of 78.3 m²/g, which facilitates the contact area between the electrolyte solution and the electrode, and reduces the current density; and (4) the linear hierarchical structure is easy to mix well with the conductive agent, thereby increasing the effective conductive contact among the wires and improving the effective transport of the electrons. Therefore, the lithium titanate material of this structure has excellent lithium ion battery charge and discharge performance, with the average battery capacities kept at 240, 218, 208, 196, 198, 186, 180 and 162 mAhg⁻¹ respectively at various charge and discharge rates of 1 C, 2 C, 5 C, 10 C, 15 C, 20 C and 50 C. In particular, it can maintain a high discharge capacity of 162 mAhg⁻¹ at an ultrafast charge and discharge rate of 50 C, which is much higher than other reported linear titanate materials.

### Example 2

Firstly, 2 g of tetrabutyl titanate was dispersed in 100 ml of water, and then 5 ml of 30% hydrogen peroxide was added thereto under stirring to form a suspension containing titanium peroxo-complex. Next, 3.5 g of lithium hydroxide was added to the above peroxo-complex suspension under stirring to form a pale-yellow transparent solution. Subsequently, the pale-yellow transparent solution was heated to 80° C. and stirred at a constant temperature for 6 hours to obtain a linear structure lithium peroxotitanate as a white product. The reaction was stopped, and separation and drying were carried out to obtain the white solid. Subsequently, the above dried white solid was placed in an oven at 150° C. and treated for 4 hours, to obtain a linear structure lithium peroxotitanate having peroxy removed on the surface thereof. Subsequently, the above white solid was dispersed in 100 ml of water and subjected to a hydrothermal reaction at 120° C. for 6 hours to obtain a linear hierarchical structure lithium titanate precursor. Finally, the linear hierarchical structure lithium titanate precursor obtained above was heated at 450° C. for 4 hours, to obtain a linear hierarchical structure lithium titanate material.

The XRD crystal phase pattern of the linear hierarchical structure lithium titanate material obtained in this example is consistent with FIG. 1, which completely coincides with the standard spinel-type lithium titanate (PDF card No. 49-0207) in its standard peaks. Thus, it is confirmed to be a spinel-type lithium titanate.

The SEM image of the linear hierarchical structure lithium titanate material obtained in this example is shown in FIG. 6. It can be seen that the linear structure is a hollow linear structure and has an aspect ratio of greater than 10, wherein the linear structure having an aspect ratio of 10 to 100 accounts for up to 90% or more. It can also be seen from the Figure that the linear hierarchical structure lithium titanate material has a diameter of 20 nm to 1 μm and a length of 1 μm to 50 μm, wherein the linear structure having a diameter of 50 nm to 500 nm and a length of 5 μm to 20 μm accounts for up to 60%. It can be seen from the Figure that the linear structure is a linear hierarchical structure whose surface is composed of nanosheet particles. The nanosheets have a size of 5 nm to 300 nm, wherein the nanosheets having a size of 10 nm to 100 nm account for up to 80%. It can also be seen from the Figure that nanosheets have a thickness of 1 nm to 20 nm, wherein the nanosheets having a thickness of 1 nm to 10 nm account for up to 80%.

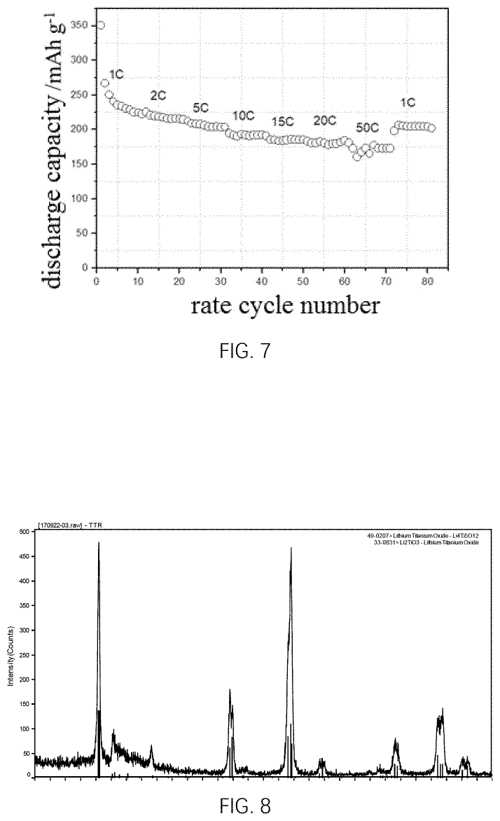

The results of a discharge capacity test of a lithium ion battery having the linear hierarchical structure lithium titanate material obtained in this example as an electrode material at different charge and discharge rates are shown in FIG. 5. The lithium ion battery electrode was prepared using knife coating process. Firstly, a slurry was prepared in a mass ratio of lithium titanate product:Super P:polyvinylidene fluoride (PVDF)=7:2:1 with N-methylpyrrolidone (NMP) as solvent. Subsequently the slurry was uniformly applied on a copper foil using a knife coater, and then a model CR2032 button cell was assembled in a glove box with metallic lithium as a counter electrode, 1 mol/L LiPF₆/EC-DMC-EMC (1:1:1) as the electrolyte solution, and Glass Fiber as a separator and it was electrochemically tested. As can be seen from FIG. 7, the structure of the material has the following characteristics: (1) the linear structure has a large aspect ratio which is mainly 10 to 100, and can greatly reduce the grain boundary between the particles compared with the nanoparticles, facilitate the effective migration of electrons in the long-axis direction, and improve the overall conductivity of the electrode material; (2) the nanosheets of the sheet-like hierarchical structure mainly have a thickness of 1 to 10 nm, which gives a very short lithium ion migration path, and thus can quickly improve the intercalation and deintercalation process of lithium ions and enhance the rate charge and discharge performance; (3) due to having the hollow structure, the hierarchical structure has a large specific surface area of 90.7 m²/g, which facilitates the contact area between the electrolyte solution and the electrode, and reduces the current density; and (4) the linear hierarchical structure is easy to mix well with the conductive agent, thereby increasing the effective conductive contact among the wires and improving the effective transport of the electrons. Therefore, the lithium titanate material of this structure has excellent lithium ion battery charge and discharge performance, with the average battery capacities kept at 235, 225, 207, 193, 184, 180 and 173 mAhg⁻¹ respectively at various charge and discharge rates of 1 C, 2 C, 5 C, 10 C, 15 C, 20 C and 50 C. In particular, it can maintain a high discharge capacity of 173 mAhg⁻¹ at an ultrafast charge and discharge rate of 50 C, which is much higher than other reported linear titanate materials.

### Example 3

Firstly, 1 g of titanic acid was dispersed in 100 ml of water, and then 6 ml of 30% hydrogen peroxide was added thereto under stirring to form a suspension containing titanium peroxo-complex. Next, 4 g of lithium hydroxide was added to the above peroxo-complex suspension under stirring to form a pale-yellow transparent solution. Subsequently, the pale-yellow transparent solution was heated to 90° C. and stirred at a constant temperature for 5 hours to obtain a linear structure lithium peroxotitanate as a white product. The reaction was stopped, and separation and drying were carried out to obtain the white solid. Subsequently, the above white solid was dispersed in 100 ml of an aqueous alcohol solution having a ratio of isopropanol to water of 1:5, and subjected to a hydrothermal reaction at 100° C. for 8 hours, to obtain a linear hierarchical structure lithium titanate precursor. Finally, the linear hierarchical structure lithium titanate precursor obtained above was heated at 300° C. for 6 hours, to obtain a linear hierarchical structure lithium titanate material.

The XRD crystal phase pattern of the linear hierarchical structure lithium titanate material obtained in this example is shown in FIG. 8, which coincides with the standard spinel-type lithium titanate (PDF card No.: 49-0207) and monoclinic lithium titanate (PDF card No.: 33-0831) crystal phase in its standard peaks. Thus, it is confirmed to be a composite crystal phase of spinel-type lithium titanate and monoclinic lithium titanate.

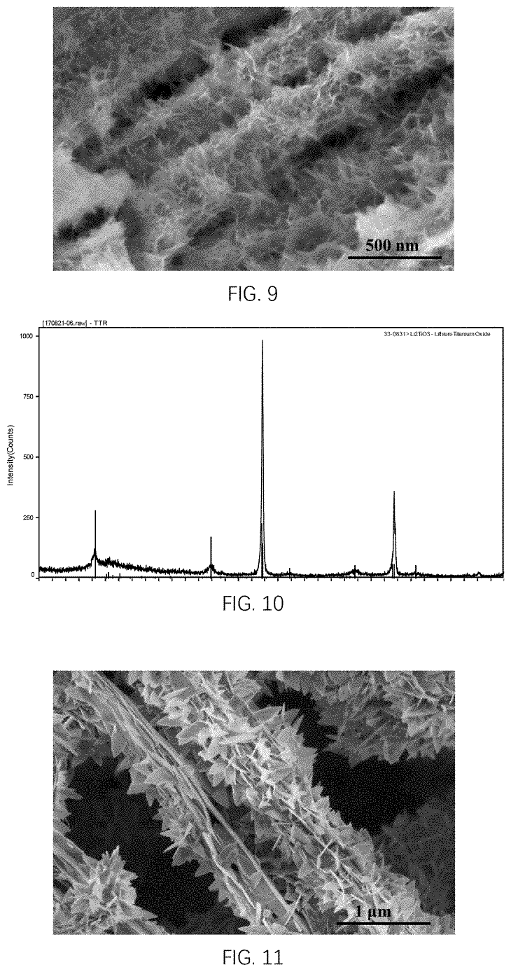

The SEM image of the linear hierarchical structure lithium titanate material obtained in this example is shown in FIG. 9. It can be seen that the linear structure is a solid linear structure and has an aspect ratio of greater than 10, wherein the linear structure having an aspect ratio of 10 to 100 accounts for up to 80% or more. It can also be seen from the Figure that the linear hierarchical structure lithium titanate material has a diameter of 20 nm to 1 μm and a length of 1 μm to 50 μm, wherein the linear structure with a diameter of 50 nm to 500 nm and a length of 5 μm to 20 μm accounts for up to 60%. It can be seen from the Figure that the linear structure is a linear hierarchical structure whose surface is composed of nanosheet particles. The nanosheets have a size of 5 nm to 300 nm, wherein the nanosheets having a size of 10 nm to 100 nm account for up to 80%. It can also be seen from the Figure that the nanosheets have a thickness of 1 nm to 20 nm, wherein the nanosheets having a thickness of 1 nm to 10 nm account for up to 80%.

A lithium ion battery prepared by using the linear hierarchical structure lithium titanate material of this example as an electrode was tested to have a capacity performance close to that of the testing results of Example 1.

### Example 4

Under stirring, 2 g of titanium oxysulfate was dispersed and dissolved into 100 ml of water to form a solution, then aqueous ammonia at a concentration of 0.1 mol/L was slowly added dropwise to the solution until the solution was neutral (pH is about 7), so that titanium oxysulfate was gradually and completely hydrolyzed to form a hydrated titanic acid precipitate. Subsequently, the hydrated titanic acid precipitate was ultrasonically dispersed, washed several times with deionized water, and separated by centrifugation. Thereafter, hydrogen peroxide and lithium hydroxide were dissolved in water to form an aqueous solution having a lithium hydroxide concentration of 0.8 mol/L and a hydrogen peroxide volume fraction of 3%. Subsequently, the separated hydrated titanic acid precipitate was dispersed in 100 ml of the above-prepared aqueous hydrogen hydroxide solution containing lithium hydroxide, and stirred to form a yellow transparent solution. Next, the above yellow transparent solution was heated to 70° C. and then stirred under constant temperature for 10 hours, to obtain a linear structure lithium peroxotitanate white product. The reaction was stopped, and separation and drying were carried out to obtain the white solid. Subsequently, the above white solid was dispersed in 100 ml of an aqueous alcohol solution having a ratio of ethanol to water of 5:1, and subjected to a solvothermal reaction at 120° C. for 12 hours, to obtain a linear hierarchical structure lithium titanate precursor. Finally, the linear hierarchical structure lithium titanate precursor obtained above was heated at 600° C. for 3 hours, to obtain a linear hierarchical structure lithium titanate material.

The XRD crystal phase pattern of the linear hierarchical structure lithium titanate material obtained in this example is shown in FIG. 10, which coincides with the standard monoclinic lithium titanate (PDF card No.: 33-0831) crystal phase in its standard peaks. Thus, it is confirmed to be a monoclinic lithium titanate crystal phase.

The SEM image of the linear hierarchical structure lithium titanate material obtained in this example is shown in FIG. 11. It can be seen that the product has a linear structure, with a diameter of 20 nm to 1 μm, a length of 1 μm to 50 μm and an aspect ratio of larger than 10. The linear structure is a linear hierarchical structure whose surface is composed of nanosheet particles. The nanosheets have a size of 5 nm to 300 nm and a thickness of 1 nm to 20 nm.

A lithium ion battery prepared by using the linear hierarchical structure lithium titanate material of this example as an electrode was tested to have a capacity performance close to that of the testing results of Example 1.

### Example 5

Firstly, 0.3 g of titanium sulfate was dispersed in 100 ml of water, and then 2 g of urea peroxide was added thereto under stirring to form a suspension containing titanium peroxo-complex. Next, 1 g of lithium peroxide was added to the above peroxo-complex suspension under stirring to form a pale-yellow transparent solution. Subsequently, the pale-yellow transparent solution was heated to 60° C. and stirred at a constant temperature for 24 hours to obtain a linear structure lithium peroxotitanate as a white product. The reaction was stopped, and separation and drying were carried out to obtain the white solid. Subsequently, the above white solid was dispersed in 100 ml of water, and subjected to a hydrothermal reaction at 100° C. for 12 hours, to obtain a linear hierarchical structure lithium titanate precursor. Finally, the linear hierarchical structure lithium titanate precursor obtained above was heated at 350° C. for 6 hours, to obtain a linear hierarchical structure lithium titanate material. The SEM image of the obtained linear hierarchical structure lithium titanate material is close to that of the product of Example 1.

A lithium ion battery prepared by using the linear hierarchical structure lithium titanate material of this example as an electrode was tested to have a capacity performance close to that of the testing results of Example 1.

### Example 6

Firstly, 8 g of titanic acid was dispersed in 100 ml of water, and then 25 ml of 30% hydrogen peroxide was added thereto under stirring to form a suspension containing titanium peroxo-complex. Next, 3 g of lithium oxide was added to the above peroxo-complex suspension under stirring to form a pale-yellow transparent solution. Subsequently, the pale-yellow transparent solution was heated to 100° C. and stirred at a constant temperature for 1 hour to obtain a linear structure lithium peroxotitanate as a white product. The reaction was stopped, and separation and drying were carried out to obtain the white solid. Subsequently, the above white solid was dispersed in 100 ml of water, and subjected to a hydrothermal reaction at 150° C. for 2 hours, to obtain a linear hierarchical structure lithium titanate precursor. Finally, the linear hierarchical structure lithium titanate precursor obtained above was heated at 700° C. for 1 hour, to obtain a linear hierarchical structure lithium titanate material. The SEM image of the obtained linear hierarchical structure lithium titanate material is close to that of the product of Example 1.

A lithium ion battery prepared by using the linear hierarchical structure lithium titanate material of this example as an electrode was tested to have a capacity performance close to that of the testing results of Example 1.

### Example 7

Firstly, 3 g of hydrated titanium oxysulfate was dispersed in 100 ml of water, and then 5 ml of 30% peracetic acid was added thereto under stirring to form a suspension containing titanium peroxo-complex. Next, 3 g of lithium superoxide was added to the above peroxo-complex suspension under stirring to form a pale-yellow transparent solution. Subsequently, the pale-yellow transparent solution was heated to 90° C. and stirred at a constant temperature for 3 hours to obtain a linear structure lithium peroxotitanate as a white product. The reaction was stopped, and separation and drying were carried out to obtain the white solid. Subsequently, the above white solid was dispersed in 100 ml of water having lithium hydroxide at a concentration of 0.1 mol/L, and subjected to a hydrothermal reaction at 140° C. for 3 hours, to obtain a linear hierarchical structure lithium titanate precursor. Finally, the linear hierarchical structure lithium titanate precursor obtained above was heated at 650° C. for 3 hours, to obtain a linear hierarchical structure lithium titanate material. The SEM image of the obtained linear hierarchical structure lithium titanate material is close to that of the product of Example 1.

A lithium ion battery prepared by using the linear hierarchical structure lithium titanate material of this example as an electrode was tested to have a capacity performance close to that of the testing results of Example 1.

### Example 8

Firstly, 3 g of tetrabutyl titanate was dispersed in 100 ml of water, and then 6 ml of 30% hydrogen peroxide was added thereto under stirring to form a suspension containing titanium peroxo-complex. Next, 3 g of lithium hydroxide was added to the above peroxo-complex suspension under stirring to form a pale-yellow transparent solution. Subsequently, the pale-yellow transparent solution was heated to 70° C. and stirred at a constant temperature for 12 hours to obtain a linear structure lithium peroxotitanate as a white product. The reaction was stopped, and separation and drying were carried out to obtain the white solid. Subsequently, the above white solid was dispersed in 100 ml of water having nitric acid at a concentration of 0.1 mol/L, and subjected to a hydrothermal reaction at 110° C. for 8 hours, to obtain a linear hierarchical structure lithium titanate precursor. Finally, the linear hierarchical structure lithium titanate precursor obtained above was heated at 600° C. for 4 hours, to obtain a linear hierarchical structure lithium titanate material. The SEM image is close to that of the product of Example 1.

A lithium ion battery prepared by using the linear hierarchical structure lithium titanate material of this example as an electrode was tested to have a capacity performance close to that of the testing results of Example 1.

### Example 9

Firstly, 3 g of tetrabutyl titanate is dispersed in 100 ml of an aqueous hydroxypropyl methyl cellulose solution at a concentration of 0.1%, and then 6 ml of 30% hydrogen peroxide was added thereto under stirring to form a suspension containing titanium peroxo-complex. Next, 3 g of lithium hydroxide was added to the above peroxo-complex suspension under stirring to form a pale-yellow transparent solution. Subsequently, the pale-yellow transparent solution was heated to 75° C. and stirred at a constant temperature for 10 hours to obtain a linear structure lithium peroxotitanate as a white product. The reaction was stopped, and separation and drying were carried out to obtain the white solid. Subsequently, the above white solid was dispersed in 100 ml of an aqueous alcohol solution having a ratio of methanol to water of 1:1, and subjected to a solvothermal reaction at 80° C. for 24 hours, to obtain a linear hierarchical structure lithium titanate precursor. Finally, the linear hierarchical structure lithium titanate precursor obtained above was heated at 350° C. for 8 hours, to obtain a linear hierarchical structure lithium titanate material. The SEM image of the obtained linear hierarchical structure lithium titanate material is close to that of the product of Example 1.

A lithium ion battery prepared by using the linear hierarchical structure lithium titanate material of this example as an electrode was tested to have a capacity performance close to that of the testing results of Example 1.

### Example 10

Firstly, 2 g of titanium isopropoxide is dispersed in 100 ml of an aqueous polyvinyl alcohol solution at a concentration of 0.5%, and then 5 ml of 30% hydrogen peroxide was added thereto under stirring to form a suspension containing titanium peroxo-complex. Next, 3.5 g of lithium hydroxide was added to the above peroxo-complex suspension under stirring to form a pale-yellow transparent solution. Subsequently, the pale-yellow transparent solution was heated to 85° C. and stirred at a constant temperature for 6 hours to obtain a linear structure lithium peroxotitanate as a white product. The reaction was stopped, and separation and drying were carried out to obtain the white solid. Subsequently, the above white solid was dispersed in 100 ml of water, and subjected to a hydrothermal reaction at 120° C. for 6 hours, to obtain a linear hierarchical structure lithium titanate precursor. Finally, the linear hierarchical structure lithium titanate precursor obtained above was immersed in 50 ml of a glucose solution having a concentration of 1 mol/L, centrifuged and dried, and then heated in an inert atmosphere at 550° C. for 4 hours to obtain a carbon-supported linear hierarchical structure lithium titanate material. The SEM image of the obtained linear hierarchical structure lithium titanate material is close to that of the product of Example 1.

A lithium ion battery prepared by using the linear hierarchical structure lithium titanate material of this example as an electrode was tested to have a capacity performance close to that of the testing results of Example 1.

### Example 11

Firstly, 1.5 g of titanium isopropoxide was dispersed in 100 ml of water, and then 4 ml of 30% hydrogen peroxide was added thereto under stirring to form a suspension containing titanium peroxo-complex. Next, 3 g of lithium hydroxide was added to the above peroxo-complex suspension under stirring to form a pale-yellow transparent solution. Subsequently, the pale-yellow transparent solution was heated to 75° C. and stirred at a constant temperature for 8 hours to obtain a linear structure lithium peroxotitanate as a white product. The reaction was stopped, and separation and drying were carried out to obtain the white solid. Subsequently, the above dried white solid was placed in an oven at 150° C. and treated for 4 hours, to obtain a linear structure lithium peroxotitanate having peroxy removed on the surface thereof. Subsequently, the above white solid was dispersed in 100 ml of water and subjected to a hydrothermal reaction at 120° C. for 6 hours to obtain a linear hierarchical structure lithium titanate precursor. Finally, the linear hierarchical structure lithium titanate precursor obtained above was heated at 450° C. for 4 hours, to obtain a linear hierarchical structure lithium titanate material. The SEM image of the obtained linear hierarchical structure lithium titanate material is close to that of the product of Example 1.

A lithium ion battery prepared by using the linear hierarchical structure lithium titanate material of this example as an electrode was tested to have a capacity performance close to that of the testing results of Example 1.

### Example 12

Firstly, 0.5 g of titanium sulfate was dispersed in 100 ml of water, and then 2.5 g of urea peroxide was added thereto under stirring to form a suspension containing titanium peroxo-complex. Next, 1.2 g of lithium peroxide was added to the above peroxo-complex suspension under stirring to form a pale-yellow transparent solution. Subsequently, the pale-yellow transparent solution was heated to 65° C. and stirred at a constant temperature for 20 hours to obtain a linear structure lithium peroxotitanate as a white product. The reaction was stopped, and separation and drying were carried out to obtain the white solid. Subsequently, the above dried white solid was placed in an oven at 200° C. and treated for 1 hour, to obtain a linear structure lithium peroxotitanate having peroxy removed on the surface thereof. Subsequently, the above white solid was dispersed in 100 ml of water, and subjected to a hydrothermal reaction at 150° C. for 2 hours, to obtain a linear hierarchical structure lithium titanate precursor. Finally, the linear hierarchical structure lithium titanate precursor obtained above was heated at 550° C. for 3 hours, to obtain a linear hierarchical structure lithium titanate material. The SEM image of the obtained linear hierarchical structure lithium titanate material is close to that of the product of Example 1.

A lithium ion battery prepared by using the linear hierarchical structure lithium titanate material of this example as an electrode was tested to have a capacity performance close to that of the testing results of Example 1.

### Example 13

Firstly, 8 g of titanic acid was dispersed in 100 ml of water, and then 25 ml of 30% hydrogen peroxide was added thereto under stirring to form a suspension containing titanium peroxo-complex. Next, 3 g of lithium oxide was added to the above peroxo-complex suspension under stirring to form a pale-yellow transparent solution. Subsequently, the pale-yellow transparent solution was heated to 100° C. and stirred at a constant temperature for 2 hours to obtain a linear structure lithium peroxotitanate as a white product. The reaction was stopped, and separation and drying were carried out to obtain the white solid. Subsequently, the above dried white solid was placed in an oven at 120° C. and treated for 10 hours, to obtain a linear structure lithium peroxotitanate having peroxy removed on the surface thereof. Subsequently, the above white solid was dispersed in 100 ml of water, and subjected to a hydrothermal reaction at 100° C. for 12 hours, to obtain a linear hierarchical structure lithium titanate precursor. Finally, the linear hierarchical structure lithium titanate precursor obtained above was heated at 350° C. for 8 hours, to obtain a linear hierarchical structure lithium titanate material. The SEM image of the obtained linear hierarchical structure lithium titanate material is close to that of the product of Example 1.

A lithium ion battery prepared by using the linear hierarchical structure lithium titanate material of this example as an electrode was tested to have a capacity performance close to that of the testing results of Example 1.

### Example 14

Firstly, 2.5 g of titanium isopropoxide was dispersed in 100 ml of an aqueous polyvinyl alcohol solution at a concentration of 0.8%, and then 6 ml of 30% hydrogen peroxide was added thereto under stirring to form a suspension containing titanium peroxo-complex. Next, 4 g of lithium hydroxide was added to the above peroxo-complex suspension under stirring to form a pale-yellow transparent solution. Subsequently, the pale-yellow transparent solution was heated to 80° C. and stirred at a constant temperature for 8 hours to obtain a linear structure lithium peroxotitanate as a white product. The reaction was stopped, and separation and drying were carried out to obtain the white solid. Subsequently, the above dried white solid was placed in an oven at 180° C. and treated for 2 hours, to obtain a linear structure lithium peroxotitanate having peroxy removed on the surface thereof. Subsequently, the above white solid was dispersed in 100 ml of an aqueous alcohol solution having a ratio of ethanol to water of 1:1, and subjected to a solvothermal reaction at 150° C. for 1 hour, to obtain a linear hierarchical structure lithium titanate precursor. Next, the linear hierarchical structure lithium titanate precursor obtained above was heated at 650° C. for 3 hours to obtain a linear hierarchical structure lithium titanate material. Finally, the linear hierarchical structure lithium titanate precursor obtained above was immersed in 50 ml of an aqueous graphene oxide solution having a concentration of 0.1%, and dried, and then subjected to an annealing treatment in an inert atmosphere at 500° C. for 5 hours to obtain a graphene-supported linear hierarchical structure lithium titanate material. The SEM image of the obtained linear hierarchical structure lithium titanate material is close to that of the product of Example 1.

A lithium ion battery prepared by using the linear hierarchical structure lithium titanate material of this example as an electrode was tested to have a capacity performance close to that of the testing results of Example 1.

### Example 15

Under stirring, 0.5 g of titanium tetrachloride was dispersed and dissolved into 100 ml of water to form a solution, then an aqueous sodium hydroxide solution at a concentration of 0.01 mol/L was slowly added dropwise to the solution until the solution was neutral (pH is about 7), so that titanium tetrachloride was gradually and completely hydrolyzed to form a hydrated titanic acid precipitate. Subsequently, the hydrated titanic acid precipitate was ultrasonically dispersed, washed several times with deionized water, and separated by centrifugation. Thereafter, hydrogen peroxide and lithium hydroxide were dissolved in water to form an aqueous solution having a lithium hydroxide concentration of 0.4 mol/L and a hydrogen peroxide volume fraction of 1%. Subsequently, the separated hydrated titanic acid precipitate was dispersed in 100 ml of the above-prepared aqueous hydrogen hydroxide solution containing lithium hydroxide under stirring to form a yellow transparent solution. Next, the above yellow transparent solution was heated to 60° C. and then stirred at constant temperature for 24 hours. The reaction was stopped, and separation and drying were carried out to obtain the white solid. Subsequently, the above white solid was dispersed in 100 ml of water, and subjected to a hydrothermal reaction at 130° C. for 5 hours, to obtain a linear hierarchical structure lithium titanate precursor. Finally, the linear hierarchical structure lithium titanate precursor obtained above was heated at 400° C. for 5 hours, to obtain a linear hierarchical structure lithium titanate material. The SEM image of the obtained linear hierarchical structure lithium titanate material is close to that of the product of Example 1.

A lithium ion battery prepared by using the linear hierarchical structure lithium titanate material of this example as an electrode was tested to have a capacity performance close to that of the testing results of Example 1.

### Example 16

Under stirring, 5 g of titanium sulfate was dispersed and dissolved into 100 ml of water to form a solution, then an aqueous potassium hydroxide solution at a concentration of 0.5 mol/L was slowly added dropwise to the solution until the solution was neutral (pH is about 7), so that titanium sulfate was gradually and completely hydrolyzed to form a hydrated titanic acid precipitate. Subsequently, the hydrated titanic acid precipitate was ultrasonically dispersed, washed several times with deionized water, and separated by centrifugation. Thereafter, hydrogen peroxide and lithium hydroxide were dissolved in water to form an aqueous solution having a lithium hydroxide concentration of 1.0 mol/L and a hydrogen peroxide volume fraction of 8%. Subsequently, the separated hydrated titanic acid precipitate was dispersed in 100 ml of the above-prepared aqueous hydrogen hydroxide solution containing lithium hydroxide under stirring to form a yellow transparent solution. Next, the above yellow transparent solution was heated to 100° C. and then stirred at constant temperature for 1 hour. The reaction was stopped, and separation and drying were carried out to obtain the white solid. Subsequently, the above white solid was dispersed in 100 ml of water, and subjected to a hydrothermal reaction at 140° C. for 4 hours, to obtain a linear hierarchical structure lithium titanate precursor. Finally, the linear hierarchical structure lithium titanate precursor obtained above was heated at 600° C. for 3 hours, to obtain a linear hierarchical structure lithium titanate material. The SEM image of the obtained linear hierarchical structure lithium titanate material is close to that of the product of Example 1.

A lithium ion battery prepared by using the linear hierarchical structure lithium titanate material of this example as an electrode was tested to have a capacity performance close to that of the testing results of Example 1.

### Example 17

Under stirring, 1 g of titanium isopropoxide was dispersed in 100 ml of an aqueous solution for direct hydrolysis to form a hydrated titanic acid precipitate. Subsequently, the hydrated titanic acid precipitate was ultrasonically dispersed, washed several times with deionized water, and separated by centrifugation. Thereafter, hydrogen peroxide and lithium hydroxide were dissolved in water to form an aqueous solution having a lithium hydroxide concentration of 0.6 mol/L and a hydrogen peroxide volume fraction of 2%. Subsequently, the separated hydrated titanic acid precipitate was dispersed in 100 ml of the above-prepared aqueous hydrogen hydroxide solution containing lithium hydroxide under stirring to form a yellow transparent solution. Next, the above yellow transparent solution was heated to 85° C. and then stirred at constant temperature for 5 hours. The reaction was stopped, and separation and drying were carried out to obtain the white solid. Subsequently, the above dried white solid was placed in an oven at 160° C. and treated for 3 hours, to obtain a linear structure lithium peroxotitanate having peroxy removed on the surface thereof. Subsequently, the above white solid was dispersed in 100 ml of water and subjected to a hydrothermal reaction at 130° C. for 5 hours to obtain a linear hierarchical structure lithium titanate precursor. Finally, the linear hierarchical structure lithium titanate precursor obtained above was heated at 350° C. for 8 hours, to obtain a linear hierarchical structure lithium titanate material. The SEM image of the obtained linear hierarchical structure lithium titanate material is close to that of the product of Example 1.

A lithium ion battery prepared by using the linear hierarchical structure lithium titanate material of this example as an electrode was tested to have a capacity performance close to that of the testing results of Example 1.

### Example 18

Under stirring, 3 g of tetrabutyl titanate was dispersed in 100 ml of an aqueous solution for direct hydrolysis to form a hydrated titanic acid precipitate. Subsequently, the hydrated titanic acid precipitate was ultrasonically dispersed, washed several times with deionized water, and separated by centrifugation. Thereafter, hydrogen peroxide and lithium hydroxide were dissolved in water to form an aqueous solution having a lithium hydroxide concentration of 0.7 mol/L and a hydrogen peroxide volume fraction of 4%. Subsequently, the separated hydrated titanic acid precipitate was dispersed in 100 ml of the above-prepared aqueous hydrogen hydroxide solution containing lithium hydroxide under stirring to form a yellow transparent solution. Next, the above yellow transparent solution was heated to 70° C. and then stirred at constant temperature for 6 hours. The reaction was stopped, and separation and drying were carried out to obtain the white solid. Subsequently, the above dried white solid was placed in an oven at 130° C. and treated for 10 hours, to obtain a linear structure lithium peroxotitanate having peroxy removed on the surface thereof. Subsequently, the above white solid was dispersed in 100 ml of an aqueous alcohol solution having a ratio of ethanol to water of 1:1 and subjected to a solvothermal reaction at 100° C. for 8 hours to obtain a linear hierarchical structure lithium titanate precursor. Finally, the linear hierarchical structure lithium titanate precursor obtained above was heated at 550° C. for 4 hours, to obtain a linear hierarchical structure lithium titanate material. The SEM image of the obtained linear hierarchical structure lithium titanate material is close to that of the product of Example 1.

A lithium ion battery prepared by using the linear hierarchical structure lithium titanate material of this example as an electrode was tested to have a capacity performance close to that of the testing results of Example 1.

What is claimed is:

1. A linear hierarchical structure lithium titanate material, wherein the crystal phase of the lithium titanate material is a spinel-type crystal phase or a monoclinic crystal phase or a composite crystal phase thereof; the lithium titanate material is mainly composed of a linear hierarchical structure; the linear hierarchical structure has an aspect ratio larger than 10; and the surface components of the linear hierarchical structure lithium titanate material are nanosheets.

2. The linear hierarchical structure lithium titanate material according to claim 1, wherein the linear hierarchical structure of lithium titanate is a solid linear structure or a hollow linear structure.

3. The linear hierarchical structure lithium titanate material according to claim 1, wherein the linear hierarchical structure has a diameter of 20 nm to 1 μm and a length of 1 μm to 50 μm.

4. The linear hierarchical structure lithium titanate material according to claim 1, wherein the nanosheets have a size of 5 nm to 300 nm.

5. The linear hierarchical structure lithium titanate material according to claim 1, wherein the nanosheets have a thickness of 1 nm to 20 nm.

6. The linear hierarchical structure lithium titanate material according to claim 1, wherein, the surface of the linear hierarchical structure lithium titanate material is further loaded with one or more selected from the group consisting of carbon, carbon nanotubes, graphene, black phosphorus, metals, and semiconductors.

7. The linear hierarchical structure lithium titanate material according to claim 1, wherein the linear hierarchical structure lithium titanate material is produced by a preparation method comprising the following steps:
(1) preparing a linear structure lithium peroxotitanate;
(2) subjecting the linear structure lithium peroxotitanate obtained in the step (1) to a hydrothermal reaction or a solvothermal reaction to obtain a linear hierarchical structure lithium titanate precursor;
(3) subjecting the linear hierarchical structure lithium titanate precursor obtained in the step (2) to an annealing treatment to obtain the linear hierarchical structure lithium titanate material.

8. The linear hierarchical structure lithium titanate material according to claim 7, wherein the method further comprises the preparation of a linear structure lithium peroxotitanate, comprising the followings steps:
(a1) preparing a dispersion containing titanium peroxo-complex;
(b1) adding a lithium compound into the dispersion containing titanium peroxo-complex obtained in the step (a1) to form a solution;
(c1) subjecting the solution obtained in the step (b1) to a reaction under heating to obtain the linear structure lithium peroxotitanate;
alternatively, comprising the followings steps:
(a2) subjecting a titanium source to a hydrolysis reaction to form a hydrated titanic acid precipitate;
(b2) dispersing the hydrated titanic acid precipitate obtained in the step (a2) in an aqueous hydrogen peroxide solution containing lithium hydroxide, and stirring to form a solution;
(c2) subjecting the solution obtained in the step (b2) to a reaction under heating to obtain the linear structure lithium peroxotitanate.

9. The linear hierarchical structure lithium titanate material according to claim 8, wherein the method further comprises subjecting the linear structure lithium peroxotitanate obtained in the step (c1) and the step (c2) to a low-temperature treatment for decomposition and removal of peroxy on the surface of the linear structure lithium peroxotitanate, to obtain the linear structure lithium peroxotitanate having peroxy removed on the surface thereof.

10. The linear hierarchical structure lithium titanate material according to claim 9, wherein the low-temperature treatment is carried out at a temperature of 120° C. to 200° C. for 1 h to 12 h.

11. The linear hierarchical structure lithium titanate material according to claim 7, wherein a reaction system of the hydrothermal reaction is selected from a pure water system, an acidic water system or an alkaline water system; and the hydrothermal reaction is carried out at a temperature of 100° C. to 150° C. for 1 h to 24 h.

12. The linear hierarchical structure lithium titanate material according to claim 7, wherein the solvothermal reaction is selected from an aqueous alcohol solution system or an alcohol solution system; and the solvothermal reaction is carried out at a temperature of 80° C. to 150° C. for 1 h to 24 h.

13. The linear hierarchical structure lithium titanate material according to claim 7, wherein the annealing treatment is carried out at a temperature of 300° C. to 700° C. for 1 h to 24 h.

14. The linear hierarchical structure lithium titanate material according to claim 8, wherein the titanium peroxo-complex in the dispersion containing titanium peroxo-complex has a concentration of 0.01 mol/L to 1 mol/L.

15. The linear hierarchical structure lithium titanate material according to claim 8, wherein the method further comprises the process for preparing a dispersion containing titanium peroxo-complex, comprising the step of: dispersing a titanium compound into an aqueous peroxide solution to form a dispersion, so as to obtain the dispersion containing titanium peroxo-complex.

16. The linear hierarchical structure lithium titanate material according to claim 15, wherein the titanium compound is selected from one or more of metallic titanium, titanium ethoxide, titanium isopropoxide, tetrabutyl titanate, titanium glycolate, titanium glyceroxide, titanium sulfate, titanium oxysulfate, titanium tetrachloride, titanium tetrafluoride, ammonium fluorotitanate, titanium nitride, titanium oxide, and titanic acid; the peroxide is selected from one or more of hydrogen peroxide, urea peroxide and peracetic acid.

17. The linear hierarchical structure lithium titanate material according to claim 15, wherein the method further comprises, after dispersing a titanium compound into an aqueous peroxide solution to form a dispersion, adding a polymer into the dispersion, to obtain the dispersion containing titanium peroxo-complex.

18. The linear hierarchical structure lithium titanate material according to claim 17, wherein the polymer is selected from one or more of chitosan, guar, methyl cellulose, ethyl cellulose, hydroxyethyl cellulose, hydroxypropyl cellulose, hydroxypropyl methyl cellulose, polyvinyl alcohol, polyacrylamide, polyethylene oxide, polyethylene glycol, and polyvinylpyrrolidone.

19. The linear hierarchical structure lithium titanate material according to claim 17, wherein the polymer is added in an amount such that the content of the polymer in the obtained dispersion containing titanium peroxo-complex is 0.01% to 10% by mass.

20. The linear hierarchical structure lithium titanate material according to claim 8, wherein the lithium compound is selected from one or more of lithium hydroxide, lithium oxide, lithium peroxide, and lithium superoxide.

21. The linear hierarchical structure lithium titanate material according to claim 8, wherein the lithium compound is added in an amount such that the concentration of lithium ions in the solution formed by adding the lithium compound is 0.4 mol/L to 2.0 mol/L.

22. The linear hierarchical structure lithium titanate material according to claim 8, wherein in the step (c1) and the step (c2), the reaction under heating is independently carried out at a temperature of 60° C. to 100° C. for 0.5 h to 24 h.

23. The linear hierarchical structure lithium titanate material according to claim 8, wherein the titanium source is selected from one or more of titanium ethoxide, titanium isopropoxide, tetrabutyl titanate, titanium glycolate, titanium glyceroxide, titanium sulfate, titanium oxysulfate, titanium tetrachloride, titanium tetrafluoride, ammonium fluorotitanate, titanium nitride, titanic acid, and industrial titanium-containing compounds.

24. The linear hierarchical structure lithium titanate material according to claim 8, wherein in the step (a2), the hydrolysis reaction comprises dispersing the titanium source in water for hydrolysis to produce a hydrated titanic acid precipitate, or the hydrolysis reaction comprises dispersing the titanium source in an aqueous solution containing an alkaline substance for hydrolysis to produce a hydrated titanic acid precipitate.

25. The linear hierarchical structure lithium titanate material according to claim 8, the step (a2) further comprises a step of purifying the obtained hydrated titanic acid precipitate crude product after hydrolysis and using the purified hydrated titanic acid precipitate in the step (b2); wherein the purification is selected from one or more of water washing—separation by centrifugation, water washing—membrane separation, water washing—filtration and dialysis.

26. The linear hierarchical structure lithium titanate material according to claim 8, wherein in the step (b2), the concentration of lithium hydroxide in the aqueous hydrogen hydroxide solution containing lithium hydroxide is 0.4 mol/L to 2.0 mol/L.

27. The linear hierarchical structure lithium titanate material according to claim 26, wherein the volume fraction of hydrogen peroxide in the aqueous hydrogen hydroxide solution containing lithium hydroxide is 0.5% to 10%.

28. The linear hierarchical structure lithium titanate material according to claim 7, wherein the method further comprises a step of loading the surface of the obtained linear hierarchical structure lithium titanate material with one or more of carbon, carbon nanotubes, graphene, black phosphorus, metals and semiconductors, when the linear hierarchical structure lithium titanate material is obtained after the annealing treatment in the step (3).

29. A method for preparing the linear hierarchical structure lithium titanate material according to claim 7, wherein the method comprises the steps of:
(1) preparing a linear structure lithium peroxotitanate;
(2) subjecting the linear structure lithium peroxotitanate obtained in the step (1) to a hydrothermal reaction or a solvothermal reaction to obtain a linear hierarchical structure lithium titanate precursor;
(3) subjecting the linear hierarchical structure lithium titanate precursor obtained in the step (2) to an annealing treatment to obtain the linear hierarchical structure lithium titanate material.

30. An electrode material for ion battery, wherein the electrode material is mainly composed of the linear hierarchical structure lithium titanate material according to claim 1.

31. The electrode material according to claim 30, wherein the ion battery is selected from lithium ion battery, sodium ion battery, potassium ion battery, or magnesium ion battery.
